(19) United States
(12) Patent Application Publication
(10) Pub. No.: US 2025/0245482 A1
(43) Pub. Date: Jul. 31, 2025

(54) METHOD AND SYSTEM FOR COORDINATING NEURAL NETWORKS TO IDENTIFY DIFFERENT ITEMS

(71) Applicant: Nrby, Inc., Manchester, NH (US)

(72) Inventor: Jeremy R. Breau, Overland Park, KS (US)

(21) Appl. No.: 19/040,735

(22) Filed: Jan. 29, 2025

Related U.S. Application Data
(60) Provisional application No. 63/626,489, filed on Jan. 29, 2024.

(51) Int. Cl. G06N 3/045

(52) U.S. Cl. CPC G06N 3/045

(57) ABSTRACT

Method and computer-readable media for coordinating multiple neural networks (or multiple AI or machine learning models) to identify one or more items within a data set. The method includes receiving, from a first neural network (or first model), a request to identify at least one neural network (or model) configured to identify at least one item within a data element. The method includes providing, to the first neural network, an identity of the at least one neural network (or model) configured to identify the at least one item within the data element. The method includes receiving, from each of the at least one neural networks (or models), a classification indication that indicates proficiency in identifying at least one specific item. The method includes identifying the at least one neural network (or model) configured to identify the at least one item within the data element.

### CROSS REFERENCE TO RELATED APPLICATION(S)

This application claims the benefit of and priority to U.S. Provisional Application Ser. No. 63/626,489, entitled “METHOD AND SYSTEM FOR COORDINATING NEURAL NETWORKS TO IDENTIFY DIFFERENT ITEMS” and filed on Jan. 29, 2024, which is expressly incorporated by reference herein in its entirety.

### INTRODUCTION

The present disclosure relates generally to computer processing components to assist in machine learning and artificial intelligence based systems.

Machine learning (ML) and artificial intelligence (AI) based systems may be used for various applications. An AI/ML model may be trained for a particular purpose or application. After the model training, input information may be input to the trained model to generate an output. The results of the output from the trained model may be provided as feedback to further train the model. In some aspects, the model may be a machine learning model that uses statistical algorithms to perform tasks or provide predictive analytics. Among other examples, AI/ML models may be used for search engines, recommendation systems, and/or creative tools.

### SUMMARY

The use of artificial intelligence and machine learning models can include centralized models that accumulate and process data from multiple sources. These centralized models may be trained to identify or classify one or more items within a data set. Aspects presented herein provide a system with an interconnect component that allows for the coordination of the centralized models to identify or classify one or more items within a data set.

Aspects disclosed herein enable a coordination entity to coordinate between one or more centralized models using artificial intelligence (AI) or machine learning (ML) tools to identify or classify one or more items within a data set. These AI tools may be configured to process the data set and predict a confidence of the identification or classification of the one or more items within the data set. These AI tools may identify or classify, whole or in part, the one or more items within the data set. However, the ability for AI tools of the centralized models to identify all or multiple items within the data set may be challenging due in part to the centralized models being trained to identify only certain types of items within the data set, which may be less than all of or the multiple items.

Aspects presented herein provide for the coordination between multiple centralized models, such that a coordination entity or interconnect may coordinate between the multiple centralized models in the identification or classification of one or more items within a data set. The centralized models may interact with the coordination entity or interconnect to request assistance in identifying some items within the data set that have a confidence value that is below a confidence threshold. The coordination entity or interconnect may instruct a first centralized model to provide the data set to at least a second centralized model to further examine the data set to identify the one or more items within the data set with a confidence value higher than that of the first centralized model.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating a central model identifying one or more items within a data set, in accordance with various aspects of the present disclosure.

FIG. 2 illustrates an example of a system for coordinating multiple central models to identify one or more items within a data set, in accordance with various aspects of the present disclosure.

FIG. 3 is a flowchart illustrating a method for coordinating multiple central models to identify one or more items within a data set, in accordance with various aspects of the present disclosure.

FIG. 4 is a flowchart illustrating a method of a central model to identify one or more items within a data set, in accordance with various aspects of the present disclosure.

FIG. 5 is a block diagram of a computer system on which the disclosed system and method can be implemented, in accordance with various aspects of the present disclosure.

FIG. 6 illustrates an example of a model requesting model assistance information for one or more additional models to assist in object identification.

FIG. 7 illustrates an example of a neural interconnect coordinating model assistance information between models to assist in object identification for a first model.

FIG. 8 is a diagram showing an AI/ML system including an interconnect to coordinate among multiple models, in accordance with various aspects of the present disclosure.

### DETAILED DESCRIPTION

Artificial Intelligence (AI) may refer to a set software modules that constantly analyze data and propose actions for successful completion of a task or improving quality of a service. Machine Learning (ML) may refer to a constant improvement of the probability for success by receiving new data and correcting the mathematical and logical models.

AI/ML models may be utilized in systems to predict, based on a confidence rating, one or more objects that are within a data element or stream. As an example, to illustrate the concept, a neural network may be utilized to make the prediction. A convolutional neural network (CNN) is an example of a neural network that may be used as part of a trained model in a system of coordinated trained models. Aspects may be presented for a CNN to illustrate the concepts presented herein. Aspects may also be applied to other types of neural networks, for example. An AI/ML system (e.g., which may include a neural network such as a CNN) may receive information so as to train a model used by the AI/ML system to make a prediction of the objects or items within the image file. In some examples, a neural network (NN) may be specifically trained to identify a certain type of object, such as but not limited to plants, animals, or other types of objects. In such instances, the NN may identify a specific plant within the data element based on typical features of plants, such as color, foliage, leaves, stems, etc.

When an image file is submitted to the NN, the model of the NN processes the image file and performs a classification. The NN may output an identification, or inference, of a plant within the image file. However, the NN may also determine that other objects (e.g., non-plants) may be present within the image file, without identifying the other objects with a certainty that is similar to that of identifying plants. For example, the model may output an inference of the plant identification with a threshold level of reliability (or a higher reliability) and may identify one or more additional objects with a lower level of reliability or with a reduced level of specificity or categorization.

Aspects disclosed herein include a system for coordinating multiple NNs or multiple models to identify one or more items within a data set based on NNs (or set of trained models), wherein the trained models are configured to identify different items within a data set. For example, each of the trained models may be trained to identify a particular type of item, e.g., so that individual models are trained to identify particular items, a particular category of items, or a particular type of items, objects, or subject matter. For example, the system may comprise a neural interconnect that is configured to coordinate model analysis between the multiple NNs or models to assist a user in identifying the one or more items within a data set.

In some aspects, the AI/ML model may be a part of a central processing system or may be connected via a communication interface to a central processing system. The AI/ML model(s) at the central processing system and/or the other AI/ML models or CNNs that interact with the system may use machine-learning algorithms, deep-learning algorithms, neural networks, reinforcement learning, regression, boosting, or advanced signal processing methods for receiving content and identifying content of interest for particular users.

Reinforcement learning is a type of machine learning that involves the concept of taking actions in an environment in order to maximize a reward. Reinforcement learning is a machine learning paradigm. Other paradigms include supervised learning and unsupervised learning. Basic reinforcement may be modeled as a Markov decision process (MDP) with a set of environment states and agent states, as well as a set of actions of the agent. A determination may be made about a likelihood of a state transition based on an action and a reward after the transition. The action selection by an agent may be modeled as a policy. The reinforcement learning may enable the agent to learn an optimal, or nearly-optimal, policy that maximizes a reward. Supervised learning may include learning a function that maps an input to an output based on example input-output pairs, which may be inferred from a set of training data, which may be referred to as training examples. The supervised learning algorithm analyzes the training data and provides an algorithm to map to new examples.

Regression analysis may include statistical analysis to estimate the relationships between a dependent variable (e.g., an outcome variable) and one or more independent variables. Linear regression is an example of a regression analysis. Non-linear regression models may also be used. Regression analysis may include estimating, or determining, relationships of cause between variables in a dataset.

Boosting includes one or more algorithms for reducing variance or bias in supervised learning. Boosting may include iterative learning based on weak classifiers (e.g., that are somewhat correlated with a true classification) with respect to a distribution that is added to a strong classifier (e.g., that is more closely correlated with the true classification) in order to convert weak classifiers to stronger classifiers. The data weights may be readjusted through the process, e.g., related to accuracy.

Among others, examples of machine learning models or neural networks that may be included in the AI/ML model at the central processing system and/or the AI/ML model at each of the remote customer systems include, for example, artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

In some aspects, an example machine learning model, such as an artificial neural network (ANN), that includes an interconnected group of artificial neurons (e.g., neuron models) as nodes. Neuron model connections may be modeled as weights, in some aspects. Machine learning models, such as the AI/ML model at the central processing system and/or the AI/ML model at each of a plurality of CNNs, may provide predictive modeling, adaptive control, and other applications through training via a dataset relating to interactions with various data elements. A machine learning model may be adapted, e.g., based on external or internal information processed by the machine learning model. In some aspects, a machine learning model may include a non-linear statistical data model and/or a decision making model. Machine learning may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. The term layer may indicate an operation on input data. Weights, biases, coefficients, and operations may be adjusted in order to achieve an output closer to the target output. Weights and biases are examples of parameters of a trained machine learning model. Different layers of a machine learning model may be trained separately.

A variety of connectivity patterns, e.g., including any of feed-forward networks, hierarchical layers, recurrent architectures, feedback connections, etc., may be included in a machine learning model. Layer connections may be fully connected or locally connected. For a fully connected network, a first layer neuron may communicate an output to each neuron in a second layer. Each neuron in the second layer may receive input from each neuron in the first layer. For a locally connected network, a first layer neuron may be connected to a subset of neurons in the second layer, rather than to each neuron of the second layer. A convolutional network may be locally connected and may be configured with shared connection strengths associated with the inputs for each neuron in the second layer. In a locally connected layer of a network, each neuron in a layer may have the same, or a similar, connectivity pattern, yet having different connection strengths.

A machine learning model, artificial intelligence component, or neural network may be trained, such as training based on supervised learning to identify a particular item, content, or subject matter. During training, the machine learning model may be presented with an input that the model uses to compute to produce an output. The obtained output may be compared to a target output, and the difference may be used to adjust parameters (e.g., weights, biases, coefficients, etc.) of the machine learning model in order to provide an output closer to the target output. Before training, the output may not be correct or may be less accurate than the output after adjustment of the model parameters during the training. A difference between the output and the target output, may be used to adjust weights of a machine learning model to align the output more closely with the target. The training may continue to be refined after training, e.g., based on feedback on output during use of the model in the system presented herein.

A learning algorithm may calculate a gradient vector for adjustment of the weights. The gradient may indicate an amount by which the difference between the output and the target output would increase or decrease if the weight were adjusted. The weights, biases, or coefficients of the model may be adjusted until an achievable error rate stops decreasing or until the error rate has reached a target level.

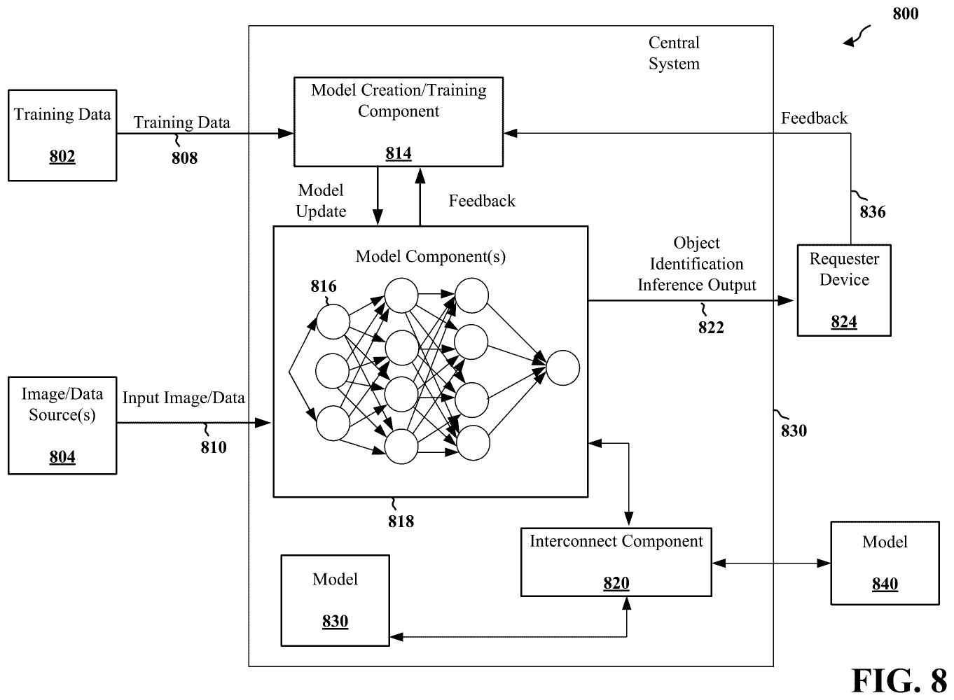

As an example, a CNN (or other AI/ML model) may be utilized to predict, infer, and/or identify objects within an image file. In some aspects, the CNN may output a prediction, inference, or identification of the object, based on a confidence rating in response to receiving input of an image file. A CNN may receive information that is applied via a training component to train the model used by the CNN to make a prediction of the objects or items within the image file. FIG. 8 illustrates an example system 800 that includes a model 818, and a training component 814 that is configured to train the model 818 based on received training data 808 from one or more training data sources 802. As an example, the training data may include a set of images and identification information for objects in the images. The identification information may be used as target output to train the model 818 via the training component 814. In some aspects, the mode 818 may include a NN that includes an interconnected group of artificial neurons (e.g. neuron models) as nodes 816. In some instances, CNNs, e.g., such as the model 818, may be specifically trained to identify a certain type of object, such as, but not limited to, plants. Plant is merely an example object category or type that is used as an example to illustrate the concept. However, the aspects presented herein may be used in connection with models that are trained for the prediction, inference, or identification associated with any particular category or type of object identification or data analysis. In an example in which the model 818 is configured to identify plants, the model 818 may identify plants based on, or including, any of various features of plants, such as color, foliage, leaves, and/or stems, etc. When an image file is submitted to the model 818 as input data (e.g., 810 from an image or data source 804), the model 818 (e.g., the CNN) is configured to process the image file and perform a classification. For example, the output 822 may include an identification of a particular type of plant in the image input, at 810. In some aspects, the output 822 may include further analysis, prediction, or inference about the plant in the image. The model 818 may identify a plant within the image file, for example. The output identification may be provided, e.g., via a communication interface (such as a modem 554, network interface 551, or other communication interface) to a device 824. In some aspects, the device 824 may have initiated a request for the identification. In some aspects, the input (e.g., 810) may also be received from the device 824 via the communication interface. In some aspects, feedback 836 about the accuracy of the output 822 may be provided to the training component 814 and used to further refine the model 818.

Additionally, or alternatively, the model 818 may also determine that other objects (e.g., non-plant objects) may be present within the image file received as input at 810, but the model 818 may not identify the other objects with certainty (e.g., with a threshold reliability level).

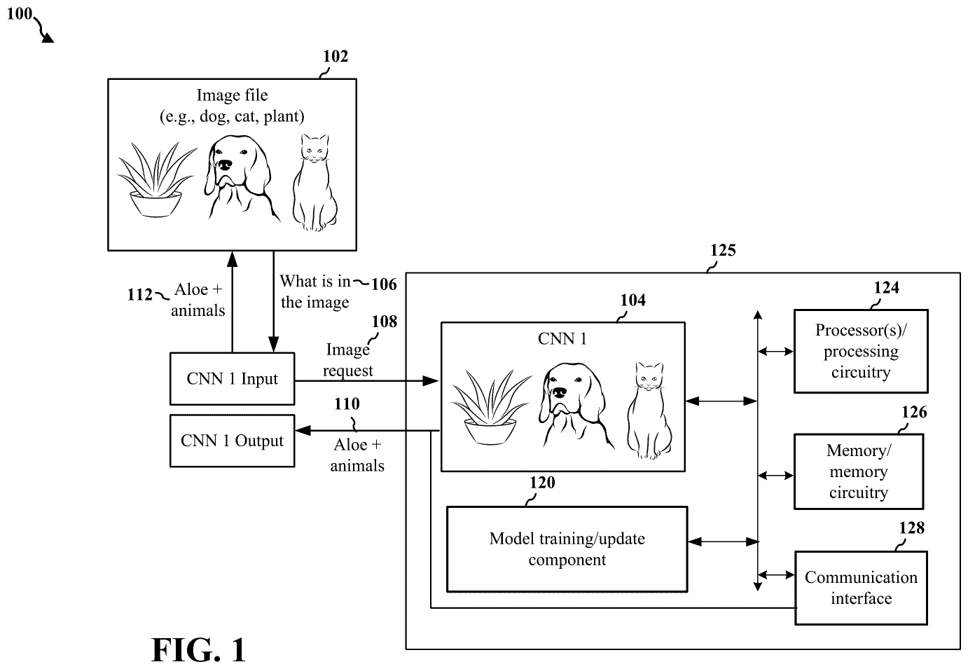

FIG. 1 illustrates a diagram 100 showing an example of a CNN 104 (e.g., as an example of a model) that is configured to identify one or more entities from a data element (e.g., image file 102). In some aspects, the CNN 104 may correspond to the model 818 in FIG. 8. Although this example includes CNN's to illustrate the concept of the present disclosure using models, the aspects are not limited to application with CNNs. The aspects presented herein may be similarly applied for other types of neural networks or other AI/ML models. In some aspects, the CNN 104 may be comprised in a CNN system 125 that includes memory 126 (or memory circuitry) and one or more processors 124 (or processor circuitry) configured to cause a computer system to perform the aspects described in connection with the use of the AI/ML model, as described herein. In some aspects, the CNN system 125 may correspond to one or more components of the system 800. The system 125 may further include a communication interface 128 that is configured to receive input for the CNN 104 and/or provide output from the CNN 104. The communication interface 128 may include a network interface, a communications port, and/or other components to enable the exchange of communication via a communication path (e.g., whether wire, cable, fiber optic, wireless link, and/or other communication channel between computer systems). FIG. 1 shows a first CNN 104 that may include one or more AI/ML models. In some aspects, the first CNN 104 may have a model configured to identifying a particular type of entity within the data element or stream. As an example, the CNN 104 may be configured to specifically identify plants using an AI/ML model. As another example, and AI/ML model may be further configured to identify other entities within the same data element or stream, but may do so a reduced confidence rating than a confidence rating for specifically identify plants. Although specific examples of AI/ML models are given to illustrate the concept, the aspects presented herein may be applied for AI/ML models for identifying various entities within a data element or stream.

In some instances, the system 125 may receive a request to identify the entities (e.g., one or more objects or subject matter) within the image file 102. The image file may comprise one or more entities that may be identified. In the example of FIG. 1, the image file 102 may comprise a plant, a dog, and a cat. However, the image file may comprise many different elements or entities and is not limited to plants, dogs, or cats. The system 125 may receive a request 106 to identify the contents within the image file 102. For example, the request 106 may be inputted via an interface (e.g., a communication interface) that is communicatively connected to the first CNN 104. The request 106 may be obtained at a CNN input and an image request 108 may be forwarded to the first CNN 104. The first CNN 104 may process the image file in to identify the contents of the image. The first CNN 104 may be trained to identify one or more entities within the image file, but may be configured or trained to identify some entities with a higher confidence rating than other entities. In some aspects, the system 125 may include a model training component 120 (e.g., which may correspond to or include aspects described in connection with 814 in FIG. 8) that provides training input for the CNN 104 and/or that receives feedback based on output from the CNN 104 and provides additional training or feedback to the CNN 104 to improve the accuracy of the output based on the CNN. For example, the first CNN 104 may be trained to identify plants, such that the first CNN may specifically identify an aloe plant as being present within the image file, but may only determine that the other entities within the image file are animals. In such instances, the first CNN 104 may provide an indication 110 that indicates that the contents of the image file comprise an aloe plant and animals. The first CNN may provide the indication 110 to the CNN output which may then provide the results 112 (e.g., aloe and animals) of the image file to the interface the submitted the request 106.

The first CNN 104 may identify some of the contents of the image file 102, but may have less accurate training to specifically identify other contents within the image file, due in part to the first CNN 104 being trained to specifically identify plants. The results from the first CNN may improperly identify some entities (e.g., other objects that are not plants) or may not return an identification for such non-plant objects. The ability to further refine the results 112 of the first CNN 104 may not be possible based on the configuration of the example of FIG. 1.

Aspects disclosed herein include a system for coordinating multiple CNNs to identify one or more items within a data set. For example, the system may comprise a neural interconnect that may coordinate between the multiple models (e.g., such as multiple CNNs) to assist in identifying the one or more items within the data set. At least one advantage of the disclosure is that multiple models (such as multiple CNNs) may be utilized to identify all of the one or more items within the data set due, in part, to the coordination between the multiple CNNs.

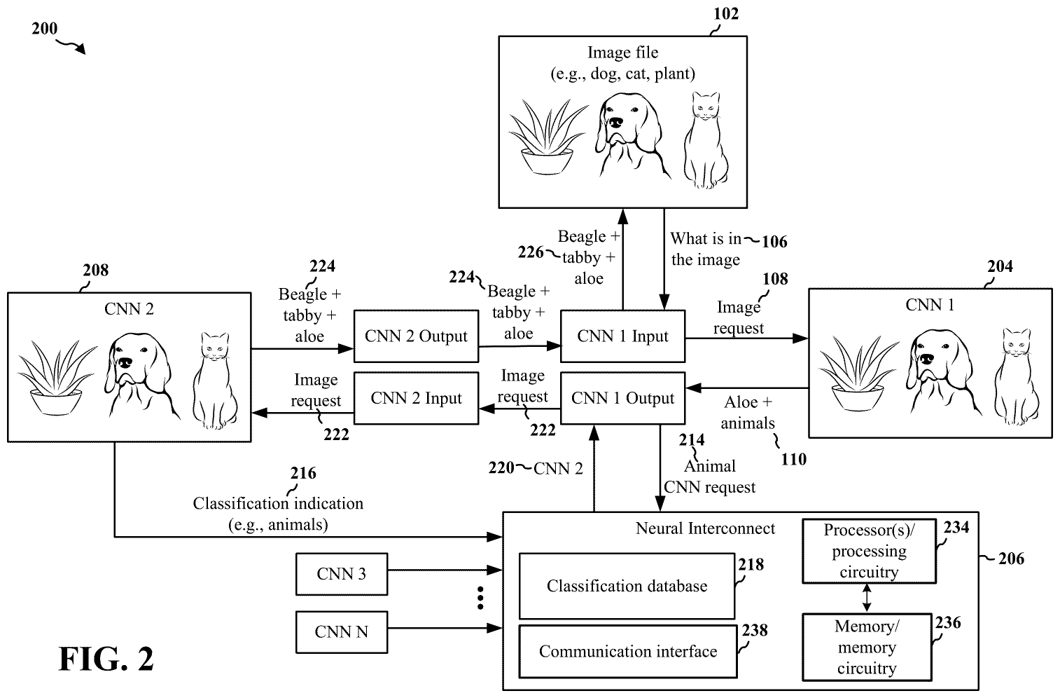

FIG. 2 is a diagram of a system 200 for coordinating inference output between multiple AI/ML models to combine the different, particular analysis of one or more different AI/ML models using coordination information maintained in a central database, e.g., at a neural interconnect 206. Although this example includes CNN's to illustrate the concept, the aspects are not limited to application with CNNs and may be similarly applied for other types of neural networks or other AI/ML models.

To illustrate the concept, FIG. 2 illustrates a system 200 for coordinating CNNs to identify one or more items within a data set, such as object identification in an image that is input (e.g., in a request) to the system 200. Other input may include text, video, audio, etc. Object identification is merely one example, and the aspects may be applied for other types of AI/ML analysis and output. As another example that is different than object identification, the combined output may be a prediction output or analysis output. As an example, the combined output may provide a business recommendation, such as a credit risk output or a credit decision. In some aspects, the system 200 may correspond to or include aspects of the system 800 described in connection with FIG. 8. The system 200 may include multiple CNNs (e.g., CNN 1 204, CNN 2 208, CNN 3, . . . CNN N). Each CNN may include, or may be included within a system including one or more aspects of the system 125 described in connection with FIG. 1. The system 200 may also include a neural interconnect 206 that may coordinate between the multiple CNNs to assist in the identification of the one or more items within the data set. The system 800 of FIG. 8 similarly illustrates an example interconnect component 820 that may connect (and communicate with) the model 818 and one or more additional models 830 and 840. Model 830 illustrates that multiple models (e.g., 818 and 830) may be included as part of a central system including the interconnect component 820 (e.g., which may exchange information with the models via a communication interface). The model 840 illustrates that the interconnect component 820 may additionally, or alternatively, interconnect and exchange information with at least one model that is separate from or remote to the central system.

The neural interconnect 206 or interconnect component 820 may also be referred to by other names, and the terms “neural interconnect” and “interconnect component” are merely used to assist in the description of the capabilities provided by the component. As illustrated in FIG. 2, in some aspects, the neural interconnect 206, or the interconnect component 820, may include one or more of memory circuitry 236, processor circuitry 234, and/or communication interface 238.

To illustrate the example of model coordination, in some instances, the first CNN 204 may be configured to receive a request to identify the entities within the image file 102, similarly as described in the example of FIG. 1. The first CNN 204 may be trained to identify plants, similarly as the first CNN 104, such that the first CNN 204 may specifically identify an aloe plant as being present within the image file 102, but may also determine that the other entities within the image file are animals. In such instances, the first CNN 204 may provide an indication 110 that indicates that the contents of the image file comprise an aloe plant and animals. The first CNN may provide the indication 110 to the CNN output. However, the CNN output may send, to the neural interconnect 206, a CNN request 214 that requests assistance in identifying animals within the image file 102. The request 214 may include descriptors, keywords, hashtags, or the like, that may be related to the other entities within the image file 102. The neural interconnect 206 may use the information within the request 214 to determine which other CNN may assist in identifying the other entities within the image file 102. For example, the CNN request 214 may indicate that animals are present within the image file 102 and may request assistance in identifying the animals within the image file 102.

The neural interconnect 206 may be configured to identify another CNN that may be specifically trained to identify or predict animals. In some aspects, the neural interconnect may reference a classification database 218 that may comprise a list of CNNs and what they may be trained to identify. The neural interconnect may receive from each of the multiple CNNs a classification indication that indicates what the CNN is trained to identify. For example, the second CNN 208 may provide a classification indication 216 to the neural interconnect 206, where the classification indication 216 indicates that the second CNN 208 is trained to identify animals. Each of the plurality of CNNs have a proficiency in identifying at least one specific item within a data element or stream. The neural interconnect 206 receives, from each of the plurality of CNNs, a classification indication that indicates the proficiency in identifying the at least one specific item. In some aspects, the second CNN 208 may provide the classification indication 216 as a means of registering or connecting with the neural interconnect 206. Other CNNs (e.g., CNN 3 or CNN N) may provide a respective classification indication to the neural interconnect, and the neural interconnect may populate the classification database 218 with each classification indication from the other CNNs.

The neural interconnect 206 may identify the second CNN 208 as being trained to identify animals based on the classification indication 216. The neural interconnect may reference the classification database 218 to identify the second CNN 208 as being trained to identify animals. The classification database 218 may indicate the confidence rating associated with each of the CNNs. In some instances, the classification database 218 may comprise multiple CNNs that may be trained to identify the same or similar items or entities within a data element or stream. In such instances, the neural interconnect may select the CNN having the higher confidence rating. In some aspects, the neural interconnect may select any of the CNNs having a confidence rating that exceeds a confidence threshold. The neural interconnect may provide, to the first CNN output, an identity indication 220 identifying the second CNN, from the plurality of CNNs, as being trained to identify animals. The neural interconnect may provide the identity of the second CNN to assist in the search request of the image file 102.

The first CNN output may send an image request 222 to the second CNN input requesting the second CNN 208 to identify the animals within the image file 102. The second CNN input may forward the image request 222 to the second CNN 208. In some aspects, the neural interconnect 206 may forward the image request 222 to the second CNN. The second CNN 208 may process the image file 102 in an effort to identify the other entities (e.g., animals) within the image file 102 that were not identified by the first CNN 204. The second CNN 208 may identify the animals as a dog and a cat, and may be configured to specifically identify the type of dog and/or the type of cat. For example, the second CNN 208 may identify the animals within the image file 102 as a beagle and a tabby cat. The second CNN 208 provides an identity indication 224 indicating the that the animals in the image file 102 are a beagle and a tabby cat, along with the aloe plant, to the second CNN output. The second CNN output provides the identity indication 224 to the first CNN input.

The first CNN input may then return the results 226 of the original image request 106 indicating that the image file 102 includes an aloe plant, a beagle, and a tabby cat. The results may be provided to the similar interface that submitted the request 106. For example, a web interface may be configured to receive input of the image file 102 and submit the request 106, such that the results 226 are displayed on the web interface. The web interface or similar interface may be accessible via many different devices, such as but not limited to a computer, smartphone, wearable device, headset, or the like.

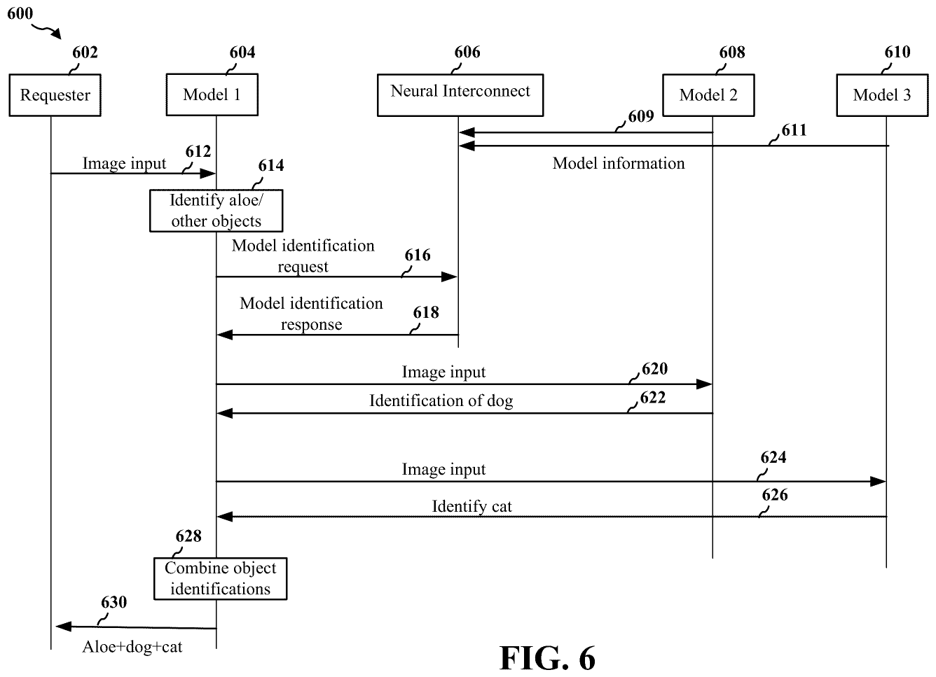

FIG. 6 illustrates an example exchange of information 600 between a first model 604 and a neural interconnect 606 to enable the first model 604 to coordinate with one or more additional models (e.g., second model 608 and/or third model 610) to provide more accurate AI/ML based results to a requester 602. In order to illustrate the concept, an example for object identification for objects within an image is used. However, the coordination between AI/ML models may also be applied for other applications that just object identification. As shown at 612, a requester 602 (which may be input by a user at a user terminal, in some examples), may provide a request 612 to a first AI/ML model 604. For example, the requester may provide an image having objects for which the identification is requested by the first model 604. The first model 604 may correspond to the CNN 204 in FIG. 2, in some aspects. The first model 604 may be trained for a particular type of analysis or AI/ML output, such as the identification of plants. The first model 604 may identify an aloe plant, at 614, in the image and may determine that the image includes additional objects for which the first model 604 has less training. As described in connection with FIG. 2, the first model 604 may send a request 616 to a neural interconnect 606. Based on model information 609 and 611 (e.g., model capabilities or training information), the neural interconnect 606 identities a second model 608 and/or a third model 610 that are trained to provide a more targeted AI/ML output for the indicated subject matter, and provides a response 618 identifying the additional models. In some aspects, the response may include information that enables the first model to access or provide a request to the additional models, such as an IP address. For example, the request 616 may indicate an animal and/or a third object type. The first model 604 may send a request 620, 624 to the second model 608 and/or the third model 610, e.g., as described in connection with FIG. 2. The first model 604 may receive output from the additional model(s), such as the identification of a particular type of dog and/or a particular type of cat, at 622, 626. As shown at 628, the first model 604 may combine the object identifications, including the objects identified by the additional models, and provides the combined model output at 630.

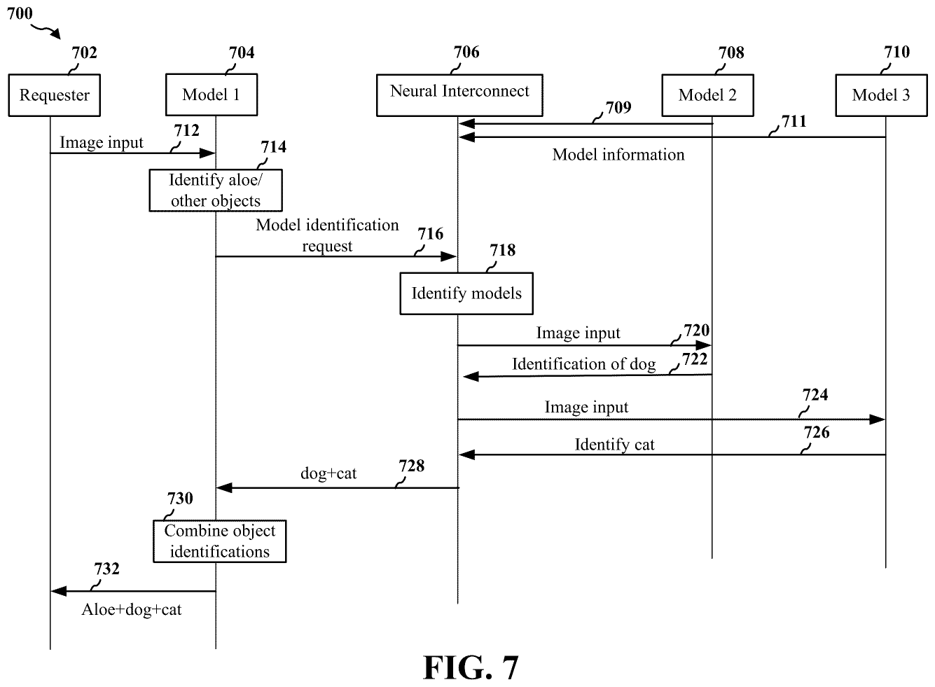

FIG. 7 illustrates an example exchange of information 700 similar to the example in FIG. 6, except in FIG. 7, the neural interconnect 706 further coordinates the exchange of model output between various AI/ML models. In order to illustrate the concept, an example for object identification for objects within an image is used. However, the coordination between AI/ML models may also be applied for other applications that just object identification. As shown at 712, a requester 702 (which may be input by a user at a user terminal, in some examples), may provide a request 712 to a first AI/ML model 704. For example, the requester may provide an image having objects for which the identification is requested by the first model 704. The first model 704 may correspond to the CNN 204 in FIG. 2, in some aspects. The first model 704 may be trained for a particular type of analysis or AI/ML output, such as the identification of plants. The first model 704 may identify an aloe plant, at 714, in the image and may determine that the image includes additional objects for which the first model 704 has less training. As described in connection with FIG. 2, the first model 704 may send a request 716 to a neural interconnect 706. Based on model information 709 and 711 (e.g., model capabilities or training information), the neural interconnect 706 identities a second model 708 and/or a third model 710 that are trained to provide a more targeted AI/ML output for the indicated subject matter, at 718. Rather than providing the identification of the models in response to the first models request, as in FIG. 6, the neural interconnect 706 may include a communication interface that enables the coordination of model output from various AI/ML models. As shown at 720 and 724, the neural interconnect 706 may send a request for object identifications of the non-plant objects to the second model 708 and the third model 710, e.g., as described in connection with FIG. 2. The neural interconnect 706 may receive output from the additional model(s), such as the identification of a particular type of dog and/or a particular type of cat, at 722, 726. The neural interconnect 706 may provide the model output (e.g., identification of the dog and cat) to the first model 704 (e.g., as a response to the request 716). The response at 728 may be provided as a combined response or the identifications can be provided separately. In some aspects, both the second model and the third model may have similar training (such as both being trained for animals or both being trained for the identification of dogs), and the returned output may be used by the first model to verify the accuracy of the model results. As shown at 730, the first model 704 may combine the object identifications, including the objects identified by the additional models, and provides the combined model output at 732.

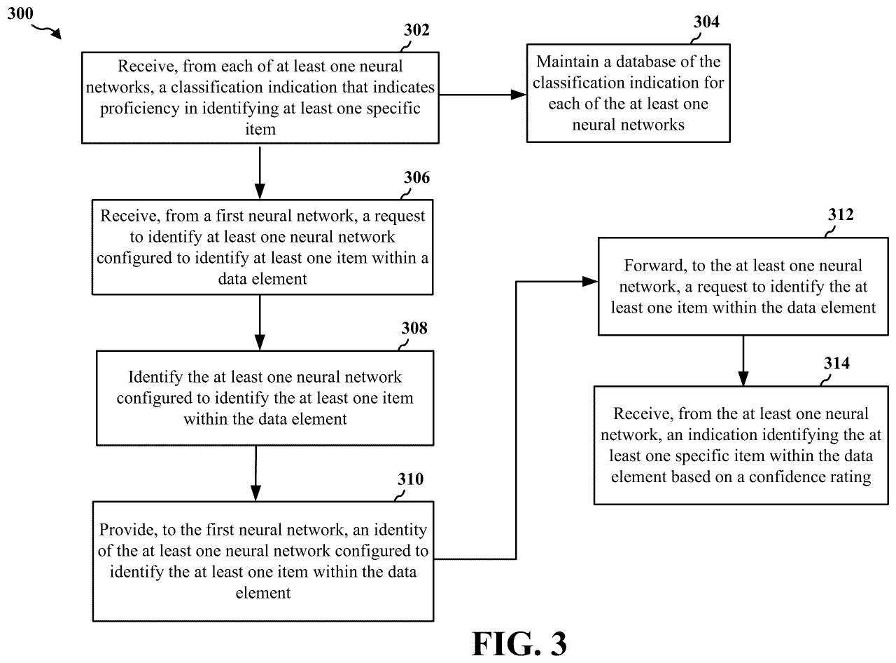

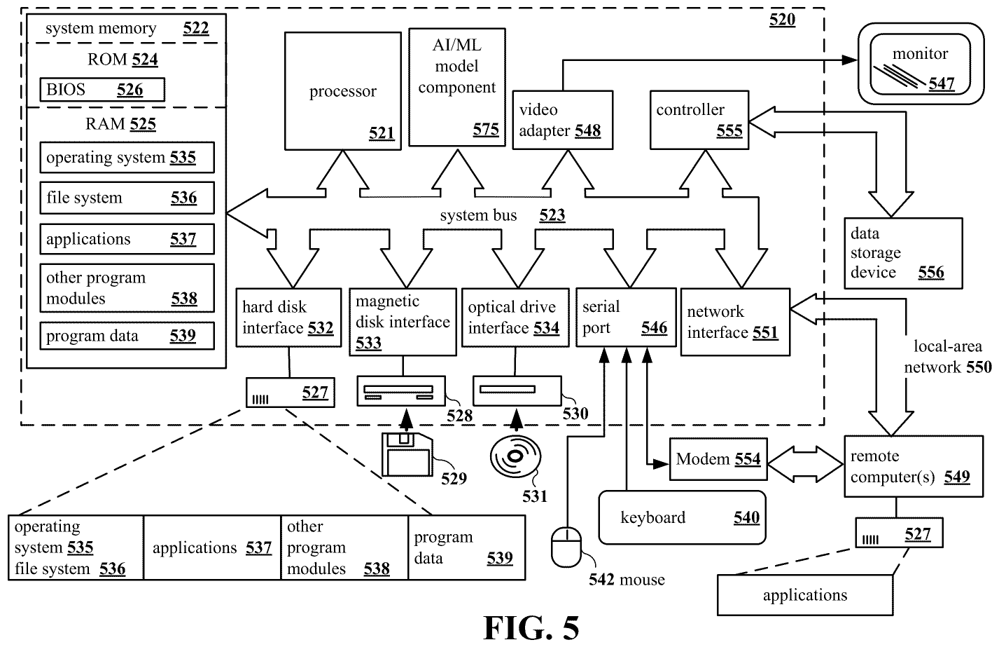

FIG. 3 is a flowchart 300 of a method of coordinating a plurality of neural networks (or AI/ML models) each having a respective central model to identify one or more items within a data set. The method may be performed at a neural interconnect (e.g., 206, 606, 706, 820) (which may also be referred to by other names) that may be configured to communicate with each of the plurality of neural networks (or models). In some aspects, the method may be performed by an AI/ML model component 575, processor 521, and/or network interface 551 of a processing system, such as illustrated in FIG. 5. In some aspects, the AI/ML model component 575 may include a neural interconnect component and/or may be configured to perform one or more aspects described in connection with the neural interconnects in any of FIG. 2, 7, or 8. The method may include any of the aspects described in connection with FIGS. 1, 2, 6, and 7, for example. For example, the neural interconnect may correspond to any of the neural interconnect (e.g., 206, 606, 706, and/or 820).

At 302, the neural interconnect may receive a classification indication. The neural interconnect may receive the classification indication from each of the plurality of neural networks or models. As an example the models may include any of 104, 204, 208, 604, 608, 610, 818, 830, or 840. The classification indication may indicate a proficiency in identifying at least one specific item for the respective neural network or model. The classification indication may indicate a proficiency, level, rating, etc. in identifying, predicting, or inferring a presence of at least one item type or object category, for example. As an example, the classification may indicate that the model is trained, configured to, or supports a capability for identification of a particular category or type of object in an image. Image analysis and object identification is merely one example to illustrate the concept, and the concept may be applied to other types of item presence within a data element, data set, or input material. In some aspects, for example at 304, the neural interconnect may maintain a database of the classification indication for each of the neural networks or models (e.g., the database storing information about the capabilities or training for the various neural networks). The database of the classification indications may allow the neural interconnect to identify a neural network or AI/ML model that is configured to identify a specific item based on a confidence rating.

At 306, the neural interconnect may receive a request to identify at least one neural network or AI/ML model that is configured to identify at least one item within a data element. The neural interconnect may receive the request to identify the at least one neural network/model from a first neural network/model. An example of a request is shown at 616 in FIG. 6, for example. For example, the first neural network/model may identify the at least one item within the data element having a reduced or low confidence rating, or at a confidence rating that is below a confidence threshold. In such instances, the first neural network/model may send a request to the neural interconnect to identify another neural network/model that has a capability to identify the at least one item within the data element with an increased confidence rating (e.g., compared to the first neural network), with a highest confidence rating among the plurality of neural networks/models, or at a confidence rating that exceeds a confidence threshold.

At 308, the neural interconnect may identify at least one neural network/model that may be configured to identify the at least one item within the data element. In some aspects, the neural interconnect may identify the at least one neural network/model that may be configured to identify the at least one item within the data element based on the database of the classification indication. In such aspects, the neural interconnect may identify the at least one neural network/model that may be configured to identify the at least one item based on a proficiency in identifying a specific item indicated within the classification indication.

At 310, the neural interconnect may respond to the first neural networks inquiry. In some aspects, the neural interconnect may provide an identity of the at least one neural network/model configured to identify the at least one item within the data element. FIG. 6 illustrates the neural interconnect 606 sending a response, at 618, with an identification of one or more models. The neural interconnect may provide the identity of the at least one neural network/model configured to identify the at least one item to the first neural network/model. The neural interconnect may provide the identity of the at least one neural network/model configured to identify the at least one item within the data element in response to the receipt of the request to identify at least one neural network/model configured to identify the at least one item within the data element.

In some aspects, for example at 312, the neural interconnect may forward a request (e.g., which may be referred to as a coordination request) to identify the at least one item within the data element. FIG. 7 illustrates an example in which the neural interconnect 706 may coordinate or exchange information with the identified model in response to the request, at 716. The neural interconnect may forward the request to identify the at least one item to the at least one neural network/model identified as being configured to identify the at least one item within the data element. For example, the neural interconnect may forward the request from the first neural network/model to the at least one neural network/model identified as being configured to identify the at least one item. In some aspects, the first neural network/model may send a request to the at least one neural network/model identified as being configured to identify the at least one item, itself, in response to receiving from the neural interconnect the identity of the at least one neural network/model identified as being configured to identify the at least one item.

At 314, neural interconnect may receive an indication identifying the at least one item or providing information about one or more characteristics of the item as analyzed, identified, inferred, or predicted by the identified neural network/model. The neural interconnect may receive the indication identifying the at least one specific item from the at least one neural network/model. The indication identifying the at least one specific item within the data element may be based on a confidence rating. In some aspects, the confidence rating may be a highest value confidence rating received. In some aspects, the confidence rating may be based on a confidence threshold.

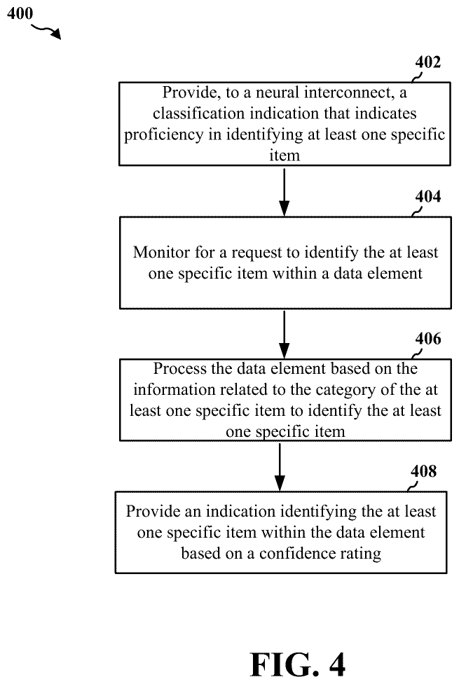

FIG. 4 is a flowchart 400 of a method of a neural network/AI/ML model that interacts with a central model for assistance in identifying one or more items within a data set in coordination with one or more additional models. In some aspects, the method may be performed by an AI/ML model component 575, processor 521, and/or network interface 551 of a processing system, such as illustrated in FIG. 5. The method may include any of the aspects described in connection with FIGS. 1, 2, 6, 7, and/or 8, for example. For example, the neural network/model may correspond to any of 204, 604, 704, and/or 818.

At 402, the neural network/model may provide a classification indication that indicates proficiency in identifying at least one specific item within a data set. The neural network/model may provide the classification indication to a neural interconnect. FIGS. 6 and 7 illustrate examples of models sending model information to a neural interconnect at 609, 611, 709, and 711, for example.

At 404, the neural network/model may monitor for a request to identify at least one specific item within a data element. The neural network/model may receive the request to identify the at least one specific item from the neural interconnect or another neural network/model. In some aspects, the request may comprise information related to a category of the at least one specific item. For example, the request may indicate some information that may assist the neural network/model in identifying the at least one specific item within the data element. FIG. 2 illustrates an example of an image file 102 that may be input in connection with a request. FIG. 6 and FIG. 7 illustrate examples of a request at 612 and 712, respectively. FIG. 8 illustrates that input data (e.g., 810) may be received for inference via one or more models.

At 406, the neural network/model may process the data clement based on the information related to the category of the at least one specific item. The neural network/model may process the data element based on the information related to the category of the at least one specific item to identify the at least one specific item.

At 408, the neural network may provide an indication identifying the at least one specific item within the data element. The neural network/model may provide the indication identifying the at least one specific item within the data element based on a confidence rating. For example, the neural network/model may be trained to identify specific items or a particular type/category of items, objects, or subject matter. The neural network may include any of the aspects described in connection with the models in FIG. 1, FIG. 2, FIG. 5, FIG. 6, FIG. 7, and/or FIG. 8.

FIG. 5 is a block diagram illustrating a general-purpose computer system 520 on which aspects of systems and methods for logic based learning between an AI/ML at a customer instance and a central AI/ML model, e.g., as described in connection with any of FIG. 2-4 or 6-8 may be implemented in accordance with an example aspect. The computer system 520 can correspond to the physical server(s) on which an image request 106/108 is executed, for example, described herein. In some aspects, the AI/ML model component 575 may be included in, or may be a component of a neural interconnect, and may be configured to perform any of the aspects described in connection with the flowchart in FIG. 3 and/or described in connection with the neural interconnect in FIG. 2, 6, 7, or 8. In some aspects, the AI/ML model component 575 may be included in or a component of a trained model, and may be configured to perform any of the aspects described in connection with the flowchart in FIG. 4 and/or described in connection with a model in FIG. 2, 6, 7, or 8.

As shown, the computer system 520 (which may be a personal computer or a server) includes a central processing unit (e.g., processor(s) 521), a system memory 522, and a system bus 523 connecting the various system components, including the memory associated with the central processing unit (e.g., 521). As will be appreciated by those of ordinary skill in the art, the system bus 523 may comprise a bus memory or bus memory controller, a peripheral bus, and a local bus that is able to interact with any other bus architecture. The system memory may include permanent memory (ROM) 524 and random-access memory (RAM) 525. The basic input/output system (BIOS) 526 may store the basic procedures for transfer of information between elements of the computer system 520, such as those at the time of loading the operating system with the use of the ROM 524.

The computer system 520 may also comprise a hard disk 527 for reading and writing data, a magnetic disk drive 528 for reading and writing on removable magnetic disks 529, and an optical drive 530 for reading and writing removable optical disks 531, such as CD-ROM, DVD-ROM and other optical media. The hard disk 527, the magnetic disk drive 528, and the optical drive 530 are connected to the system bus 523 across the hard disk interface 532, the magnetic disk interface 533, and the optical drive interface 534, respectively. The drives and the corresponding computer information media are power-independent modules for storage of computer instructions, data structures, program modules, and other data of the computer system 520.

An example aspect comprises a system that uses a hard disk 527, a removable magnetic disk 529 and a removable optical disk 531 connected to the system bus 523 via the controller 555. It will be understood by those of ordinary skill in the art that any type of media 556 that is able to store data in a form readable by a computer (solid state drives, flash memory cards, digital disks, random-access memory (RAM) and so on) may also be utilized.

The computer system 520 has a file system 536, in which the operating system 535 may be stored, as well as additional program applications 537, other program modules 538, and program data 539. A user of the computer system 520 may enter commands and information using keyboard 540, mouse 542, or any other input device known to those of ordinary skill in the art, such as, but not limited to, a microphone, joystick, game controller, scanner, etc. Such input devices typically plug into the computer system 520 through a serial port 546, which in turn is connected to the system bus, but those of ordinary skill in the art will appreciate that input devices may be also be connected in other ways, such as, without limitation, via a parallel port, a game port, or a universal serial bus (USB). A monitor 547 or other type of display device may also be connected to the system bus 523 across an interface, such as a video adapter 548. In addition to the monitor 547, the personal computer may be equipped with other peripheral output devices (not shown), such as loudspeakers, a printer, etc.

Computer system 520 may operate in a network environment, using a network connection to one or more remote computers 549. The remote computer (or computers) 549 may be local computer workstations or servers comprising most or all of the aforementioned elements in describing the nature of a computer system 520. Other devices may also be present in the computer network, such as, but not limited to, routers, network stations, peer devices or other network nodes.

Network connections can form a local-area computer network (LAN) 550 and a wide-area computer network (WAN). Such networks are used in corporate computer networks and internal company networks, and they generally have access to the Internet. In LAN or WAN networks, the computer system 520 is connected to the local-area network 550 across a network adapter or network interface 551. When networks are used, the computer system 520 may employ a modem 554 or other modules well known to those of ordinary skill in the art that enable communications with a wide-area computer network such as the Internet. The modem 554, which may be an internal or external device, may be connected to the system bus 523 by a serial port 546. It will be appreciated by those of ordinary skill in the art that said network connections are non-limiting examples of numerous well-understood ways of establishing a connection by one computer to another using communication modules.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer.

In various aspects, the systems and methods described in the present disclosure can be addressed in terms of modules. The term “module” as used herein refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module, element, or component may also be implemented as a combination of the two, with particular functions facilitated by hardware alone, and other functions facilitated by a combination of hardware and software. In particular implementations, at least a portion, and in some cases, all, of a module, element, or component may be executed on one or more processors of a general purpose computer. Accordingly, each module may be realized in a variety of suitable configurations, and should not be limited to any particular implementation or example herein. An element, or any portion of an element, or any combination of elements may be implemented as a “processing system” that includes one or more processors. When multiple processors are implemented, the multiple processors may perform the functions individually or in combination. One or more processors in a processing system may execute stored instructions, which may be referred to as software, firmware, middleware, microcode, hardware description language, or otherwise, e.g., instructions, instruction sets, code, code segments, program code, programs, subprograms, software components, applications, software applications, software packages, routines, subroutines, objects, executables, threads of execution, procedures, functions, or any combination thereof.

In one configuration, the AI/ML model component 575 and/or the computer system 520, and in particular, the file system 536 and/or the processor 521, is configured to perform the aspects of the flowchart in FIG. 3 or FIG. 4.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents. In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

As used herein, the phrase “based on” is not a reference to a closed set of information, one or more conditions, one or more factors, or the like. In other words, the phrase “based on X” (where “X” may be information, a condition, a factor, or the like) shall be construed as “based at least on X” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

The following aspects are illustrative only and may be combined with other aspects or teachings described herein, without limitation.

Aspect 1 is a computer-implemented method for identifying items at an artificial intelligence (AI) or machine learning (ML) model, comprising: receiving, from a first neural network, a request to identify at least one neural network that is configured to (e.g., that supports a capability to or is trained to) identify (e.g., predict or infer the presence of) at least one item type (or category) within a data element; and providing, to the first neural network, an identity of the at least one neural network that is configured to identify the at least one item within the data element.

In aspect 2, the method of aspect 1, further includes receiving, from each of the at least one neural networks, a classification indication that indicates proficiency in identifying at least one specific item.

In aspect 3, the method of aspect 1 or 2, further includes maintaining a database of the classification indication for each of the at least one neural networks.

In aspect 4, the method of any of aspects 1-3, further includes identifying the at least one neural network configured to identify the at least one item within the data element.

In aspect 5, the method of any of aspects 1-4, further includes forwarding, to the at least one neural network, a request to identify the at least one item within the data element.

In aspect 6, the method of any of aspects 1-5, further includes receiving, from the at least one neural network, an indication identifying the at least one specific item within the data element based on a confidence rating.

Aspect 7 is a computer-implemented method for identifying items at an artificial intelligence (AI) model, comprising: providing, to a neural interconnect, a classification indication that indicates proficiency in identifying at least one specific item; monitoring for a request to identify the at least one specific item within a data element; and providing an indication identifying the at least one specific item within the data element based on a confidence rating.

In aspect 8, the method of aspect 7 further includes that the request to identify the at least one specific item within the data element is obtained from a first neural network or the neural interconnect.

In aspect 9, the method of aspect 7 or 8 further includes that the request comprises information related to a category of the at least one specific item.

In aspect 10, the method of any of aspects 7-9 further includes processing the data element based on the information related to the category of the at least one specific item to identify the at least one specific item.

Aspect 11 is a system for identifying items at an artificial intelligence (AI) model, comprising: a first neural network configured to receive a data element and a query of the data element; a plurality of neural networks where each of the plurality of neural networks having a proficiency in identifying at least one specific item within data elements; and a neural interconnect configured to provide an identity of at least one neural network of the plurality of neural networks to assist in the query of the data element.

In aspect 12, the system of aspect 11 further includes that the neural interconnect receives, from the first neural network, a request to identify at least one neural network configured to identify at least one item within a data element.

In aspect 13, the system of aspect 11 or 12 further includes that the neural interconnect receives, from each of the plurality of neural networks, a classification indication that indicates the proficiency in identifying the at least one specific item.

In aspect 14, the system of any of aspects 11-13 further includes that the neural interconnect maintains a database of the classification indication for each of the at least one neural networks.

In aspect 15, the system of any of aspects 11-14 further includes that each of the plurality of neural networks monitor for a request to identify the at least one specific item within the data element.

In aspect 16, the system of any of aspects 11-15 further includes that each of the plurality of neural networks provide an indication identifying the at least one specific item within the data element based on a confidence rating, in response to obtaining the request to identify the at least one specific item.

In aspect 17, the system of any of aspects 11-16 further includes that the request to identify the at least one specific item within the data element is obtained from a first neural network or the neural interconnect.

In aspect 18, the system of any of aspects 11-17 further includes that the request comprises information related to a category of the at least one specific item.

In aspect 19, the system of any of aspects 11-18 further includes that at least one of the plurality of neural networks processes the data element based on the information related to the category of the at least one specific item to identify the at least one specific item.

Aspect 20 is a non-transitory computer-readable medium storing computer executable code for information modeling, the code when executed by processor circuitry causes a neural interconnect to perform the method of any of aspects 1-6.

Aspect 21 is an apparatus at a neural interconnect, comprising: a processing system that includes processor circuitry and memory circuitry that stores code and is coupled with the processor circuitry, the processing system configured to cause the neural interconnect to perform the method of one or more of aspects 1-6.

Aspect 22 is an apparatus at a neural interconnect, comprising: means for performing the method of one or more of aspects 1-6.

Aspect 23 is a non-transitory computer-readable medium storing computer executable code for information modeling, the code when executed by processor circuitry causes a neural network to perform the method of any of aspects 7-10.

Aspect 24 is an apparatus at a neural network, comprising: a processing system that includes processor circuitry and memory circuitry that stores code and is coupled with the processor circuitry, the processing system configured to cause the neural network to perform the method of one or more of aspects 7-10.

Aspect 25 is an apparatus at a neural network, comprising: means for performing the method of one or more of aspects 7-10.

Aspect 26 is a system for coordinating an identification of identifying items using a neural interconnect for coordination among a plurality of neural networks, comprising: a plurality of neural networks, wherein each neural network of the plurality of neural networks has a proficiency in identification of at least one item type within data elements; a first neural network of the plurality of neural networks, wherein the first neural network is configured to receive a data element and a query of the data element; and a neural interconnect configured to: maintain a database of the proficiency in identification for each of the plurality of neural networks; and provide an identity of at least one neural network of the plurality of neural networks to assist in the query of the data element received at the first neural network.

In aspect 27, the system of aspect 26 further includes that the neural interconnect includes a communication interface that is configured to receive, from the first neural network, a request to identify the at least one neural network based on a corresponding proficiency to identify at least one item type within the data element.

In aspect 28, the system of aspect 26 or 27 further includes that the neural interconnect is configured to: receive, from each of the plurality of neural networks, a classification indication that indicates a corresponding proficiency in identifying the at least one item type, wherein the database is maintained based on the received classification indication.

In aspect 29, the system of any of aspects 26-28 further includes that each of the plurality of neural networks include a communication interface configured to receive a coordination request to identify the at least one specific item within the data element.

In aspect 30, the system of aspect 29 further includes that each of the plurality of neural networks is further configured to provide, via the communication interface, an indication in response to obtaining the request to identify the at least one specific item, wherein the indication indicates one or more of: at least one identified item of the at least one item type within the data element based on a confidence rating, or one or more characteristics of the identified item.

In aspect 31, the system of aspect 29 or 30 further includes that the request to identify the at least one item type within the data element is obtained from the first neural network or the neural interconnect.

In aspect 32, the system of any of aspects 29-31 further includes that the request comprises information related to a category of the at least one item type.

In aspect 33, the system of aspect 32 further includes that at least one of the plurality of neural networks is configured to process the data element based on the information related to the category of the at least one specific item to identify the at least one specific item.

What is claimed is:

1. A system for coordinating item identification using a neural interconnect for coordination among a plurality of neural networks, comprising:
the plurality of neural networks, wherein each neural network of the plurality of neural networks has a proficiency in identification of at least one item type within data elements;
a first neural network of the plurality of neural networks, wherein the first neural network is configured to receive a data element and a query of the data element; and
the neural interconnect configured to:
maintain a database of the proficiency in the identification for each of the plurality of neural networks; and
provide an identity of at least one neural network of the plurality of neural networks to assist in the query of the data element received at the first neural network.

2. The system of claim 1, wherein the neural interconnect includes a communication interface that is configured to receive, from the first neural network, a request to identify the at least one neural network based on a corresponding proficiency to identify the at least one item type within the data element.

3. The system of claim 1, wherein the neural interconnect is configured to:
receive, from each of the plurality of neural networks, a classification indication that indicates a corresponding proficiency in identifying the at least one item type, wherein the database is maintained based on the received classification indication.

4. The system of claim 1, wherein each of the plurality of neural networks include a communication interface configured to receive a coordination request to identify at least one item within the data element.

5. The system of claim 4, wherein each of the plurality of neural networks is further configured to provide, via the communication interface, an indication in response to obtaining the coordination request to identify the at least one item, wherein the indication indicates one or more of:
at least one identified item of the at least one item type within the data element based on a confidence rating, or
one or more characteristics of the at least one identified item.

6. The system of claim 4, wherein the coordination request to identify the at least one item type within the data element is obtained from the first neural network or the neural interconnect.

7. The system of claim 4, wherein the coordination request comprises information related to a category of the at least one item type.

8. The system of claim 7, wherein at least one of the plurality of neural networks is configured to process the data element based on the information related to the category of the at least one item type to identify the at least one item.

9. A computer-implemented method for identifying items at neural interconnect in communication with one or more artificial intelligence (AI)/machine learning (ML) model, comprising:
receiving, from a first neural network, a request to identify at least one neural network that is configured to identify at least one item within a data element; and
providing, to the first neural network, an identity of the at least one neural network configured to identify the at least one item within the data element.

10. The method of claim 9, further comprising:
receiving, from each of the at least one neural network, a classification indication that indicates proficiency in identifying the at least one item.

11. The method of claim 10, further comprising:
maintaining a database of the classification indication for each of the at least one neural network.

12. The method of claim 10, further comprising:
identifying the at least one neural network that is configured to identify the at least one item within the data element.

13. The method of claim 12, further comprising:
forwarding, to the at least one neural network, the request to identify the at least one item within the data element.

14. The method of claim 13, further comprising:
receiving, from the at least one neural network, an indication identifying the at least one item within the data element based on a confidence rating.

15. A computer-implemented method for identifying items at an artificial intelligence (AI) model based on coordination with a neural interconnect, the method comprising:
providing, to the neural interconnect, a classification indication that indicates proficiency in identifying at least one item type;
monitoring for a request to identify the at least one item type within a data element; and
providing an indication identifying the at least one item type within the data element based on a confidence rating.

16. The method of claim 15, wherein the request to identify the at least one item type within the data element is obtained from a first neural network or the neural interconnect.

17. The method of claim 15, wherein the request comprises information related to a category of the at least one item type.

18. The method of claim 17, further comprising:
processing the data element based on the information related to the category of the at least one item type to identify an item of the at least one item type that is included within the data element.
